(19) United States
(12) Patent Application Publication
(10) Pub. No.: US 2005/0275286 A1
(43) Pub. Date: Dec. 15, 2005

(54) Brake apparatus for a vehicle

(75) Inventors: Takayuki Ohmori, Utsunomiya-shi (JP); Kunimichi Hatano, Utsunomiya-shi (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/148,768

(22) Filed: Jun. 9, 2005

(30) Foreign Application Priority Data
Jun. 11, 2004 (JP) 2004-173982

(51) Int. Cl. B60T 8/34

(52) U.S. Cl. 303/155; 303/116.1; 303/116.2

(57) ABSTRACT

A brake apparatus for a vehicle includes a brake operation unit, a master cylinder, and an electrically controlled hydraulic source. The brake apparatus also includes a wheel cylinder to retard rotation of a wheel using hydraulic pressure generated either by the master cylinder or the electrically controlled hydraulic source. The brake apparatus further includes a hydraulic path connecting the master cylinder, the wheel cylinder, and the electrically controlled hydraulic source. The brake apparatus further includes a shut-off valve electrically controlled and operated to alternatively close and open part of the hydraulic path, an operation pressure measuring unit measuring hydraulic pressure generated by the master cylinder, and a braking pressure measuring unit measuring hydraulic pressure acting on the wheel cylinder. Operation of the apparatus is controlled by a control unit capable of changing magnitude of drive current to be supplied to the shut-off valves depending on values measured by the operation pressure measuring unit and the braking pressure measuring unit.

### BACKGROUND OF THE INVENTION

1. Field of the Invention

The present invention relates to a brake apparatus applied to a vehicle such as an automobile, and in particular, relates to a brake apparatus constructed as a brake-by-wire system in which, during a normal operation state, a hydraulic path provided between a master cylinder and a wheel cylinder is shut-off, and the wheel cylinder is operated using hydraulic pressure provided by an electronically controlled hydraulic source. Priority is claimed on Japanese Patent Application No. 2004-173982, filed Jun. 11, 2004, the content of which is incorporated herein by reference.

2. Description of the Related Art

In brake apparatuses, as related art, constructed as a brake-by-wire system in which, during a normal operation state, a hydraulic path provided between a master cylinder and a wheel cylinder is shut-off, and the wheel cylinder is operated using hydraulic pressure provided by an electronically controlled hydraulic source, many apparatuses are provided with a shut-off valve which is electrically controlled and operated so as to shut-off and open a hydraulic path (see, for example, Japanese Unexamined Patent Application, First Publications No. H05-65060 and No. 2001-106056). In such an apparatus having aforementioned construction, when the hydraulic path is to be shut-off, a constant drive current is supplied to the shut-off valve. However, in such an apparatus having aforementioned construction, because the performance of the shut-off valve is determined depending on the maximum operation force of a brake pedal, the magnitude of the drive current to be supplied to the shut-off valve tends to be large, which may lead to increase in electrical power consumption and increase in an amount of self-generating heat, which may further lead to a problem in that the construction of the shut-off valve is complicated and the size and weight of the shut-off valve are increased due to necessity of an auxiliary cooling device, and due to ensuring a sufficient heat capacity so as to allow the maximum operation force of the brake pedal.

### SUMMARY OF THE INVENTION

In view of the above circumstances, an object of the present invention is to provide a brake apparatus for a vehicle in which a shut-off valve is simplified and made small and light by minimizing electrical power consumed in operating the shut-off valve so as to minimize the amount of self-generating heat.

In order to achieve the above object, the present invention provides a brake apparatus for a vehicle, including: a brake operation unit; a master cylinder mechanically generating hydraulic pressure depending on an operation force of the brake operation unit; an electrically controlled hydraulic source electrically controlled to generate hydraulic pressure separately from the master cylinder; a wheel cylinder operating so as to retard rotation of a wheel using hydraulic pressure generated by the master cylinder or the electrically controlled hydraulic source; a hydraulic path connecting the master cylinder, the wheel cylinder, and the electrically controlled hydraulic source; a shut-off valve electrically controlled and operated so as to shut-off and open the hydraulic path; an operation pressure measuring unit measuring hydraulic pressure generated by the master cylinder; a braking pressure measuring unit measuring hydraulic pressure acting on the wheel cylinder; and a control unit controlling the shut-off valve during a normal operation state so as to shut-off the hydraulic path to operate the wheel cylinder using hydraulic pressure generated by the electrically controlled hydraulic source, and changing magnitude of drive current to be supplied to the shut-off valve depending on values measured by the operation pressure measuring unit and the braking pressure measuring unit.

According to the construction described above, during a normal operation state (i.e., under unfailed conditions), the brake apparatus acts as a brake-by-wire system in which the hydraulic path is shut-off, and the wheel cylinder is operated using hydraulic pressure provided by the electronically controlled hydraulic source. On the other hand, during an electrically abnormal operation state (i.e., under failed conditions), hydraulic pressure provided by the master cylinder can be transmitted to the wheel cylinder by opening the hydraulic path so that the wheel cylinder is directly operated without using an electrical control operation.

When the shut-off valve shuts-off the hydraulic path, because the hydraulic pressure at a portion of the hydraulic path that is connected to the master cylinder (i.e., hydraulic pressure generated by the master cylinder) acts on the shut-off valve so as to open the hydraulic path, and the hydraulic pressure at a portion of the hydraulic path that is connected to the wheel cylinder (i.e., hydraulic pressure acting on the wheel cylinder) acts on the shut-off valve so as to shut-off the hydraulic path, by estimating pressure (i.e., shut-off pressure) that is required to maintain the shut-off state of the hydraulic path by the shut-off valve depending on the measured hydraulic pressure at the master cylinder side and the measured hydraulic pressure at the wheel cylinder side, and by changing magnitude of the drive current to be supplied to the shut-off valve based on the estimated pressure, it is possible, during a regular operation state of the brake operation unit in which the hydraulic pressure at the wheel cylinder side is greater than that at the master cylinder side, to efficiently operate the shut-off valve without unnecessarily increasing drive current, and it is also possible, during an irregular operation state of the brake operation unit in which the hydraulic pressure at the master cylinder side is greater than that at the wheel cylinder side, to change the drive current so as to increase the shut-off pressure in accordance with difference between the hydraulic pressures.

In the above brake apparatus, a shut-off pressure of the shut-off valve below which a shut-off state of the hydraulic path is maintained may increase in proportion with the drive current supplied to the shut-off valve.

In the above brake apparatus, the control unit may set the drive current at a constant value during a regular operation state in which the hydraulic pressure at the wheel cylinder is greater than that at the master cylinder, and the control unit may increase the drive current depending on difference between the hydraulic pressures at the master cylinder and at the wheel cylinder during an irregular operation state in which the hydraulic pressure at the master cylinder is greater than that at the wheel cylinder.

In the above brake apparatus, the control unit may increase the drive current in proportion with the difference between the hydraulic pressures at the master cylinder and at the wheel cylinder during the irregular operation state.

In the above brake apparatus, the hydraulic path may include a first hydraulic path connecting the master cylinder and the shut-off valve, and a second hydraulic path connecting the wheel cylinder and the shut-off valve. The operation pressure measuring unit may be provided in the first hydraulic path, and the braking pressure measuring unit may be provided in the second hydraulic path.

In the above brake apparatus, the electrically controlled hydraulic source may be connected to the second hydraulic path.

According to the present invention, by changing the drive current to operate the shut-off valve depending on the operation state of the brake operation unit, it is possible to minimize electrical power consumed to operate the shut-off valve, and to minimize self-generating heat of the shut-off valve. As a result, an auxiliary cooling device for the shut-off valve is not required, and the shut-off valve can be simplified and made small and light because only minimum and necessary heat capacity is required.

### BRIEF DESCRIPTION OF THE DRAWINGS

FIG. 1 is a schematic block diagram of a brake apparatus for a vehicle in an embodiment of the present invention.

FIG. 2 is a cross-sectional view showing a shut-off valve of the brake apparatus.

FIG. 3 is a graph illustrating change in drive current supplied to the shut-off valve.

FIG. 4 is a graph illustrating the relationship between pressure difference between master cylinder pressure and caliper pressure and the drive current.

### DESCRIPTION OF THE PREFERRED EMBODIMENTS

An embodiment of the present invention will be explained below with reference to the drawings.

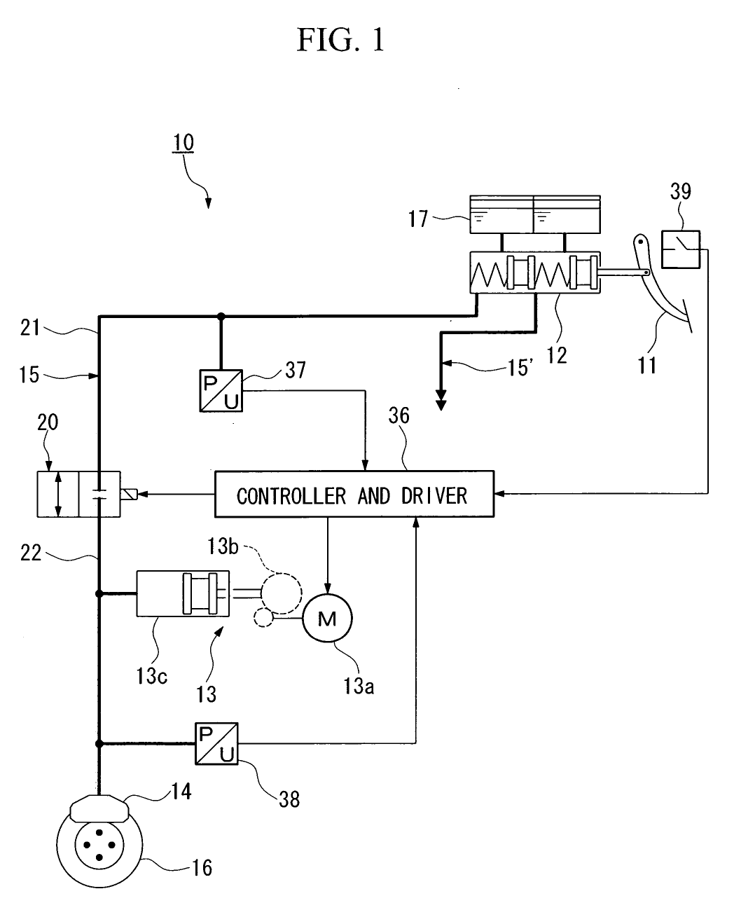

As shown in FIG. 1, a brake apparatus 10 for a vehicle in this embodiment includes a master cylinder 12 that mechanically generates hydraulic pressure (fluid pressure) depending on an operation force of a brake pedal 11 (a brake operation unit), a brake actuator 13 (an electrically controlled hydraulic source) that is electrically controlled to generate hydraulic pressure separately from the master cylinder 12, and a brake caliper 14 20 (a wheel cylinder) that operates so as to retard rotation of a wheel using the hydraulic pressure generated by the master cylinder 12 or the brake actuator 13. The brake apparatus 10 is constructed as a so-called brake-by-wire system in which, during a normal operation state, the brake caliper 14 is operated using the hydraulic pressure from the brake actuator 13 while shutting-off a hydraulic path 15 (a fluid pressure path) between the master cylinder 12 and the brake caliper 14 and brake actuator 13. In FIG. 1, thick lines indicate hydraulic lines, and thin lines indicate electrical transmission lines. Moreover, in FIG. 1, reference numeral 16 indicates a brake disc that rotates with the wheel, and reference numeral 17 indicates a reservoir tank for operation fluid in the brake apparatus 10.

In the hydraulic path 15, there is provided a shut-off valve 20 that is electrically controlled so as to shut-off and open the hydraulic path 15. A portion of the hydraulic path 15 that is located upstream of the shut-off valve 20 is denoted as a first hydraulic path 21, and a portion of the hydraulic path 15 that is located downstream of the shut-off valve 20 is denoted as a second hydraulic path 22. The master cylinder 12 is connected to the first hydraulic path 21, and the brake actuator 13 and brake caliper 14 are connected to the second hydraulic path 22.

The brake actuator 13 is a so-called motor cylinder that generates hydraulic pressure by inputting a driving force of a driving motor 13 a to a hydraulic pressure generation unit 13c via a speed reduction mechanism 13b or the like.

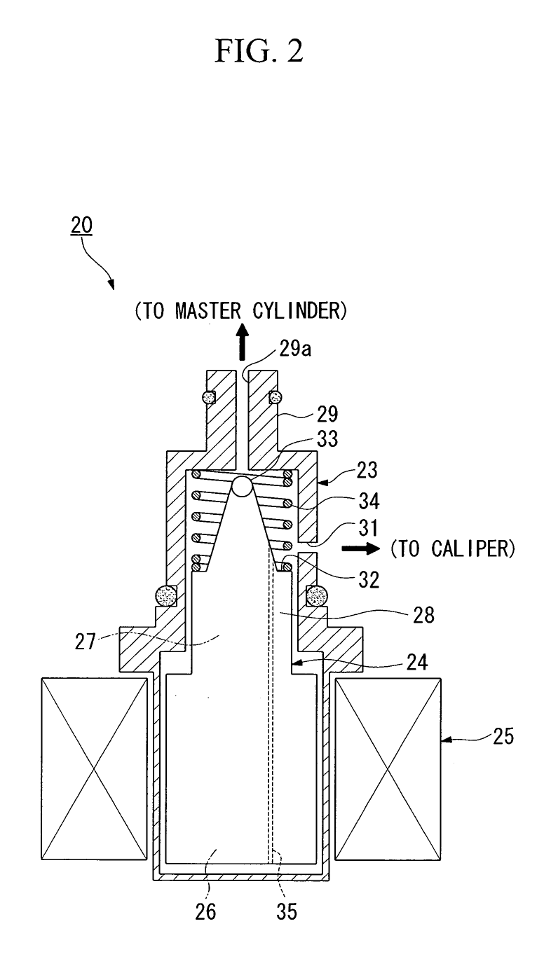

On the other hand, as shown in FIG. 2, the shut-off valve 20 is a so-called solenoid valve that shuts-off and opens the hydraulic path 15 by moving an armature 24 which is provided in a linearly movable manner in a sealed casing 23 that constitutes a portion of the hydraulic path 15 using excitation of a solenoid coil 25 that is provided outside the casing 23.

The direction of movement of the armature 24 coincides with the vertical direction in FIG. 2. Denotations of upper, lower, right, and left in the following description are denoted based on FIG. 2.

A first hydraulic chamber 26 is formed in a lower portion of the casing 23, and the body of the armature 24 is disposed therein so as to match the first hydraulic chamber 26. The solenoid coil 25 is disposed so as to surround the first hydraulic chamber 26. A second hydraulic chamber 27 that is connected to the first hydraulic chamber 26 is formed in an upper portion of the casing 23, and projection portion 28 is formed at an upper portion of the armature 24 so as to be accommodated in the second hydraulic chamber 27.

A nozzle 29 is formed at an upper end of the casing 23. The first hydraulic path 21 is connected to the nozzle 29, and thereby the first hydraulic path 21 and the second hydraulic chamber 27 are connected via a nozzle inside hydraulic path 29a. A side port 31 is formed at the right portion of the second hydraulic chamber 27 of the casing 23. The second hydraulic path 22 is connected to the side port 31, and thereby the second hydraulic path 22 and the second hydraulic chamber 27 are connected.

The armature 24 has, at a portion thereof positioned lower than the side port 31, a shoulder portion 32 that is formed by a plane which is substantially perpendicular to the direction of movement of the armature 24. The armature 24 also has, at an end portion thereof, a seat portion 33 as a valve body to close the nozzle inside hydraulic path 29a, and a portion having a tapered shape between the shoulder portion 32 and the seat portion 33.

When electrical power is supplied to the solenoid coil 25, the armature 24 moves upward, and the seat portion 33 closes the nozzle inside hydraulic path 29a, and thereby the hydraulic path 15 of the brake apparatus 10 is shut-off.

A coil spring 34 is compressed and disposed in a space between an upper wall of the second hydraulic chamber 27 and the shoulder portion 32. The armature 24 is urged downward by the elastic force of the coil spring 34. Accordingly, when supply of electrical power to the solenoid coil 25 is stopped, the armature 24 moves downward due to the elastic force of the coil spring 34, and thereby the nozzle inside hydraulic path 29a and the hydraulic path 15 are opened. Reference numeral 35 indicates a hydraulic communication path that is provided in the armature 24 to equalize hydraulic pressure in the hydraulic chambers.

The operations of the shut-off valve 20 and the brake actuator 13 are controlled by a control unit 36 shown in FIG. 1.

The control unit 36 is a so-called an ECU (Electronic Control Unit) that includes a controller and a driver for the shut-off valve 20 and the brake actuator 13, and is operated by being input electrical power from a battery or the like. A signal indicating hydraulic pressure measured by a master cylinder pressure sensor 37 (operation pressure measuring unit) as a measuring unit for measuring hydraulic pressure (master cylinder pressure) in the first hydraulic path 21, a signal indicating hydraulic pressure measured by a caliper pressure sensor 38 (braking pressure measuring unit) as a measuring unit for measuring hydraulic pressure (caliper pressure, braking pressure) in the second hydraulic path 22, and an ON/OFF signal from a brake switch 39 are input to the control unit 36.

In the brake apparatus 10, it is possible to directly operate the brake caliper 14 without using electrical control during an abnormal operation state (under failed conditions) in which, for example, the sensors 37 and 38 are failed by immediately open the hydraulic path 15 by the shut-off valve 20 so that the hydraulic pressure generated by the master cylinder 12 is transmitted to the brake caliper 14. In other words, the shut-off valve 20 acts as a failsafe valve of the brake apparatus 10.

In order to ensure failsafe, the shut-off valve 20 is constructed such that the armature 24 closes the nozzle inside hydraulic path 29a from the downstream side so that operation fluid is not allowed to flow from the downstream side (i.e., the brake caliper 14 and brake actuator 13 side) to the upstream side of the hydraulic path 15 (i.e., the master cylinder 12 side).

More specifically, even when the hydraulic pressure in the second hydraulic path 22 is transmitted through the side port 31 to the second hydraulic chamber 27, the hydraulic pressure is not transmitted to the first hydraulic path 21 because the hydraulic pressure urges the armature 24 toward the nozzle inside hydraulic path 29a; however, because the hydraulic pressure in the first hydraulic path 21 urges the armature 24 away from the nozzle inside hydraulic path 29a, the hydraulic pressure is transmitted through the second hydraulic chamber 27 to the second hydraulic path 22 when the armature 24 moves while overcoming magnetic force due to the solenoid coil 25.

To achieve such an operation in the brake apparatus 10, the control unit 36 changes the magnitude of the drive current to be supplied to the shut-off valve 20 depending on the pressure difference between the hydraulic pressure in the first hydraulic path 21 that acts so as to open the hydraulic path 15 and the hydraulic pressure in the second hydraulic path 22 that acts so as to shut-off the hydraulic path 15.

In other words, the control unit 36 executes predetermined calculations based on the measure values measured by the sensors 37 and 38, estimates pressure to be applied to the shut-off valve 20 based on the calculation results, and adjusts the drive current to be supplied to the shut-off valve 20 so that the shut-off valve 20 generates minimum pressure (hereinafter, this pressure is referred to as shut-off pressure of the shut-off valve 20) required to maintain the hydraulic path 15 in a shut-off state.

In FIG. 1, only the hydraulic path 15 corresponding to one of the wheels of the vehicle; however, it is needless to say that a second hydraulic path 15′ corresponding to another one of the wheels, and extending from the master cylinder 12 has the same construction as that of the hydraulic path 15.

Next, the operation of the brake apparatus 10 will be explained.

When the ignition is in the OFF state, and the control system of the brake apparatus 10 is not started-up, drive current is not supplied to the shut-off valve 20; therefore, the hydraulic path 15 is opened.

On the other hand, when the ignition is in the ON state, and the engine is started-up, the system is started-up (i.e., in the ON state), and a predetermined drive current is supplied to the shut-off valve 20, thereby the armature 24 moves so as to close the nozzle inside hydraulic path 29a, and the hydraulic path 15 is shut-off.

When the system is in the ON state, the brake pedal 11 is operated, and the brake switch 39 is turned on, the hydraulic pressure generated by the master cylinder 12 is not transmitted to the brake caliper 14, instead, the control unit 36 operates the brake actuator 13, and hydraulic pressure corresponding to the pressure in the first hydraulic path 21 is generated in the second hydraulic path 22. The brake caliper 14 is operated by the hydraulic pressure, and rotation of the wheel is retarded.

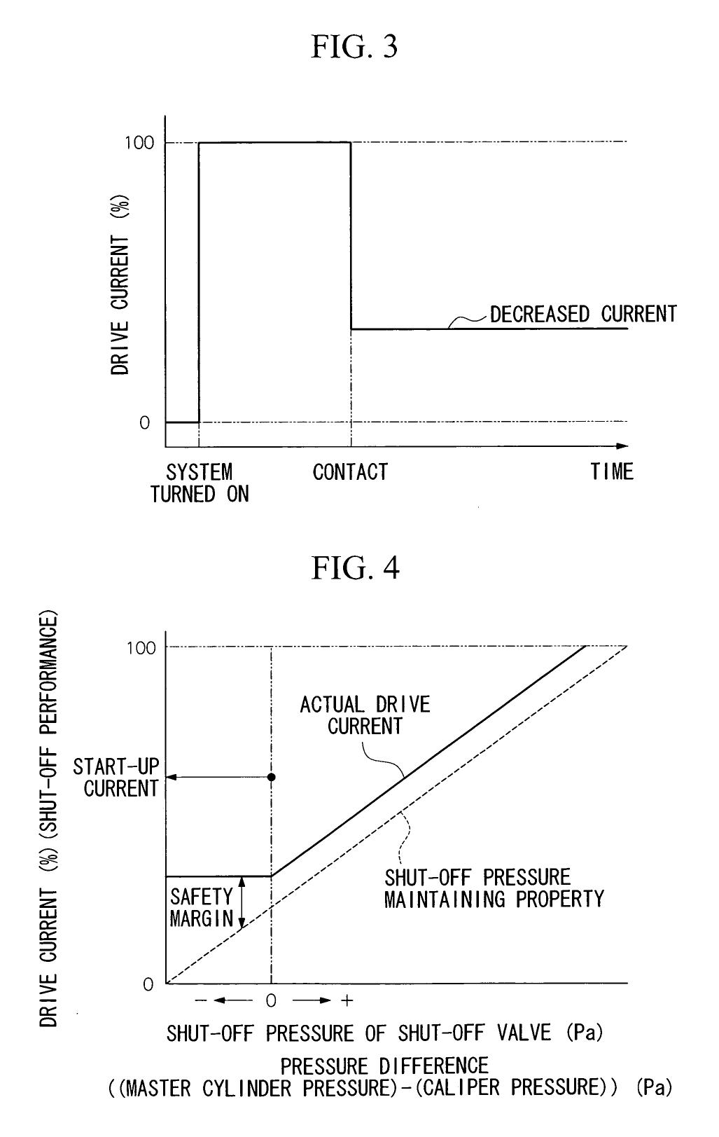

Change in the drive current supplied to the shut-off valve 20 during the operation of the brake pedal 11 will be explained with reference to FIG. 3. When the system is turned on, and a predetermined drive current is supplied to the shut-off valve 20, the armature 24 is started-up, and the hydraulic path 15 is shut-off. After starting-up of the armature 24, a holding current may be less than the start-up current; therefore, the drive current supplied to the shut-off valve 20 is decreased when a predetermined time has elapsed since the system is turned on, at which it is deemed that the nozzle inside hydraulic path 29a is completely closed due to contact of the seat portion 33 of the armature 24. Such electrical current may be referred to as decreased current in the following description. Due to such a control operation, electrical power consumed to drive the shut-off valve 20 can be reduced, and an efficient control operation can be achieved.

During a regular operation state of the brake pedal 11, because the brake actuator 13 generates, depending on a master cylinder pressure, a caliper pressure (a braking pressure) that is greater than the master cylinder pressure, the caliper pressure is greater than the master cylinder pressure, and the pressure difference between these pressures makes the armature 24 move toward the nozzle inside hydraulic path 29a so as to shut-off the hydraulic path 15. Accordingly, even in the case in which the brake apparatus 10 is designed with a safety factor, the drive current supplied to the shut-off valve 20 can be reduced; however, when considering a decreased caliper pressure due to such as an operation of an ABS (Anti-lock Brake System), the drive current must be increased so as to increase the shut-off pressure of the shut-off valve 20 because the master cylinder pressure may exceed the caliper pressure, and the pressure difference therebetween may open the hydraulic path 15. Moreover, when considering a case in which the brake pedal 11 is further depressed during the operation of the ABS, the shut-off pressure of the shut-off valve 20 must be further increased.

Next, the relationship between the aforementioned pressure difference and the drive current will be explained with reference to FIG. 4. During a regular operation state of the brake pedal 11, the pressure difference obtained by subtracting the caliper pressure from the master cylinder pressure is in a negative region. In this case, because the pressure difference acts so as to shut-off the hydraulic path 15, the drive current can be reduced as explained above after starting-up of the shut-off valve 20. The shut-off pressure of the shut-off valve 20 is in the negative region.

The property of the drive current that is required for the shut-off valve 20 to maintain the shut-off pressure is determined such that the output is set to be 0% at a point at which the absolute value of the pressure difference that is in the negative region is balanced with the elastic force of the coil spring 34, and from the point, the output is increased in proportion with the pressure difference up to 100%. The output value of the drive current supplied to the shut-off valve 20 represents the shut-off property of the shut-off valve 20.

On the other hand, the actual drive current is set to be a decreased current while being constant when the pressure difference is in the negative region while ensuring a sufficient safety margin with respect to the shut-off pressure maintaining property, and when the pressure difference is in the positive region, i.e., during an irregular operation state in which the master cylinder pressure is grater than the caliper pressure, the actual drive current is increased with the shut-off pressure maintaining property in proportion with the pressure difference while ensuring a constant safety margin. Accordingly, the shut-off pressure is continuously maintained to be greater than the pressure difference so that transmission of the hydraulic pressure from the first hydraulic path 21 to the second hydraulic path 22 can be prevented.

The irregular operation state is defined as a state in which the brake pedal 11 is depressed beyond a regular operation range such as during a quickly-applied braking. Because the vehicle speed is limited, such an irregular operation state will not continue for a long time; therefore, the shut-off valve 20 must be operated in response to the irregular operation for only a limited time.

Accordingly, because it is not necessary to design the shut-off valve 20 so as to ensure a shut-off state against a maximum pressure, instead, the shut-off valve 20 may be designed in accordance with the generated pressure, an amount of heat generated by the drive current during the regular operation state can be reduced, and only a heat capacity absorbing an amount of heat corresponding to the shut-off pressure for a limited time must be ensured. Therefore, the shut-off valve 20 can be simplified and made small and light.

As explained above, the brake apparatus 10 in the above embodiment includes the master cylinder 12 that mechanically generates hydraulic pressure depending on the operation force of the brake pedal 11, a brake actuator 13 that is electrically controlled to generate hydraulic pressure separately from the master cylinder 12, the brake caliper 14 that is operated so as to retard rotation of the wheel using the hydraulic pressure generated by the master cylinder 12 or the brake actuator 13, and the shut-off valve 20 that is electrically controlled and operated so as to shut-off and open the hydraulic path 15 connecting the master cylinder 12, the brake caliper 14, and the brake actuator 13. In the brake apparatus 10, the hydraulic path 15 is shut-off so as to operate the brake caliper 14 using hydraulic pressure generated by the brake actuator 13 during a normal operation state. The brake apparatus 10 further includes the master cylinder pressure sensor 37 and the caliper pressure sensor 38. The magnitude of the drive current to be supplied to the shut-off valve 20 is changed depending on the values measured by the sensors 37 and 38.

According to the above construction, during a normal operation state (i.e., under unfailed conditions), the brake apparatus 10 acts as a so-called brake-by-wire system in which the hydraulic path 15 is shut-off by the shut-off valve 20, and the brake caliper 14 is operated using the hydraulic pressure provided by the brake actuator 13. On the other hand, during an electrically abnormal operation state (i.e., under failed conditions), the hydraulic pressure provided by the master cylinder 12 can be transmitted to the brake caliper 14 by opening the hydraulic path 15 so that the brake caliper 14 is directly operated without using an electrical control operation.

When the shut-off valve 20 shuts-off the hydraulic path 15, because the hydraulic pressure at a portion of the hydraulic path 15 that is connected to the master cylinder 12 (i.e., hydraulic pressure generated by the master cylinder 12) acts on the shut-off valve 20 so as to open the hydraulic path 15, and the hydraulic pressure at a portion of the hydraulic path 15 that is connected to the wheel cylinder (i.e., hydraulic pressure acting on the wheel cylinder) acts on the shut-off valve 20 so as to shut-off the hydraulic path 15, by estimating pressure (i.e., shut-off pressure) that is required to maintain the shut-off state of the hydraulic path 15 by the shut-off valve 20 depending on the measured hydraulic pressure at the master cylinder 12 side and the measured hydraulic pressure at the wheel cylinder side, and by changing magnitude of the drive current to be supplied to the shut-off valve 20 based on the estimated pressure, it is possible, during a regular operation state of the brake pedal 11 in which the hydraulic pressure at the wheel cylinder side is greater than that at the master cylinder 12 side, to efficiently operate the shut-off valve 20 without unnecessarily increasing drive current, and it is also possible, during an irregular operation state of the brake pedal 11 in which the hydraulic pressure at the master cylinder 12 side is greater than that at the wheel cylinder side, to change the drive current so as to increase the shut-off pressure in accordance with difference between the hydraulic pressures.

As described above, by changing the drive current to operate the shut-off valve 20 depending on the operation state of the brake pedal 11, it is possible to minimize electrical power consumed to operate the shut-off valve 20, and to minimize self-generating heat of the shut-off valve 20. As a result, an auxiliary cooling device for the shut-off valve 20 is not required, and the shut-off valve 20 can be simplified and made small and light because only minimum and necessary heat capacity is required. Moreover, by also using a decreased current control operation in which the drive current is decreased after starting-up of the shut-off valve 20, the effect of minimizing the current consumed to operate the shut-off valve 20 is further enhanced.

The present invention is not limited to the above embodiment. For example, the means for measuring the master cylinder pressure and/or the means for measuring the caliper pressure may be a unit that is inherently employed for achieving a braking function. Moreover, the means for changing the drive current supplied to the shut-off valve may be a unit which continuously changes electrical current such as a DC amplifier, or may be a unit which changes electrical current by a switching operation. Furthermore, the means for changing the drive current may be a unit which performs modulation control such as PWM (Pulse Wide Modulation) or PCM (Pulse Code Modulation).

Moreover, the means for estimating the shut-off pressure and for changing the drive current may be a calculation means that is inherently employed for achieving a braking function. Furthermore, brake apparatuses to which the present invention is applicable should include a system in which a shut-off valve (failsafe valve) is employed; however, the means for generating hydraulic pressure (fluid pressure) is not limited.

In the control operation for the drive current, a feedback control operation may be employed by measuring the drive current in order to compensate for increase in the resistance of the solenoid coil due to increase in the temperature of the solenoid coil. Moreover, a feed-forward control operation may be employed in which a duty ratio and voltage are determined by estimating increase in the temperature of the solenoid coil by accumulating applied voltage and current applying period, and by further including a safety factor.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A brake apparatus for a vehicle comprising:
a brake operation unit;
a master cylinder for mechanically generating hydraulic pressure depending on an operation force of the brake operation unit;
an electrically controlled hydraulic source electrically controlled and operable to generate hydraulic pressure separately from the master cylinder;
a wheel cylinder operable to retard rotation of a wheel using hydraulic pressure generated either by the master cylinder or the electrically controlled hydraulic source;
a hydraulic path connecting the master cylinder, the wheel cylinder, and the electrically controlled hydraulic source;
a shut-off valve capable of being electrically controlled and operated to close and open selected portions of the hydraulic path;
an operation pressure measuring unit for measuring hydraulic pressure generated by the master cylinder;
a braking pressure measuring unit for measuring hydraulic pressure acting on the wheel cylinder; and
a control unit capable of controlling the shut-off valve during a normal operation state to close part of the hydraulic path and to operate the wheel cylinder using hydraulic pressure generated by the electrically controlled hydraulic source, and changing a magnitude of drive current supplied to the shut-off valve, depending on values measured by the operation pressure measuring unit and the braking pressure measuring unit.

2. A brake apparatus according to claim 1, wherein a shut-off pressure of the shut-off valves below which a shut-off state of the hydraulic path is maintained, increases in proportion with the drive current supplied to the shut-off valve.

3. A brake apparatus according to claim 1, wherein during operation thereof the control unit sets the drive current at a constant value during a regular operation state in which the hydraulic pressure at the wheel cylinder is greater than that at the master cylinder, and the control unit increases the drive current depending on difference between the hydraulic pressures at the master cylinder and at the wheel cylinder during an irregular operation state in which the hydraulic pressure at the master cylinder is greater than that at the wheel cylinder.

4. A brake apparatus according to claim 3, wherein during operation thereof the control unit increases the drive current in proportion with the difference between the hydraulic pressures at the master cylinder and at the wheel cylinder during the irregular operation state.

5. A brake apparatus according to claim 1, wherein the hydraulic path comprises a first hydraulic path segment connecting the master cylinder and the shut-off valve, and a second hydraulic path segment connecting the wheel cylinder and the shut-off valve, and wherein the operation pressure measuring unit is provided in the first hydraulic path segment, and the braking pressure measuring unit is provided in the second hydraulic path segment.

6. A brake apparatus according to claim 5, wherein the electrically controlled hydraulic source is connected to the second hydraulic path segment.
